(19) United States
(12) Patent Application Publication
(10) Pub. No.: US 2006/0200762 A1
(43) Pub. Date: Sep. 7, 2006

(54) Methods for printing booklets and booklets printed thereby

(76) Inventors: Israel Marmorstein, Ashdod (IL); Eliezer Katz, Ashdod (IL)

Correspondence Address: LADAS & PARRY, 26 WEST 61ST STREET, NEW YORK, NY, 10023, US

(21) Appl. No.: 11/329,673

(22) Filed: Jan. 11, 2006

(30) Foreign Application Priority Data
Mar. 7, 2005 (IL) 167,283

(51) Int. Cl. G06F 17/00; G06F 15/00

(52) U.S. Cl. 715/517

(57) ABSTRACT

The invention provides a method for preparing a portable booklet of multi-column textual material, comprising reformatting the textual layout of the material in order to create substantial alignment between the lines of text in all of the columns in an area predetermined for horizontal subdivision of the sheet containing the same, creating at least one space horizontally extending across the predetermined area of the sheet, thereby subdividing each of the respective columns to form at least two distinct areas of printed matter, and utilizing the subdivided sheets to form a booklet having pages of reduced height in the direction of its columns, while substantially maintaining the original font size of the letters of the multi-column textual material.

The present invention relates to the printing of multi-column text. More particularly, the invention provides a method of reproducing and printing large pages of a multi-column text in a manner producing a compact booklet suitable for the use of travelers.

It is often seen that those traveling wish to utilize traveling time to read or study multi-column texts. Typically such texts comprise a central primary text having commentaries or translations on both or one side thereof. The size of a book having such arrangements is typically over 30 cm and in some books close to 40 cm high and 22-28 cm wide. Books of such size are not convenient for the use of travelers, whatever mode of transportation is used, and whatever the book thickness.

Book publishers have become aware that there is a demand for readily portable books, and have responded with reduced-size editions of books of the type described. A typical reduced-size book convenient for travelers measures about 21 cm high by about 14 cm wide. Books of such modest size are conveniently hand held and when not in use can be inserted in a pocket or handbag. Pocket editions are also attractive to the publisher, as manufacturing costs are low. However, as is to be expected, the reduced size of the text makes study thereof difficult and the side commentaries, translations and notes become practically unreadable except where lighting is intense, and there is no vehicle vibration. Even so, such text is best read using a magnifying glass.

A search of US patents for prior art produced no relevant results.

It is therefore one of the objects of the present invention to obviate the disadvantages of prior-art books and booklets and to provide a method which may be used to reproduce a multi-column text book in a form suitable for travelers.

It is a further object of the present invention to provide multi-column booklets with font sizes substantially the same as the original text.

The present invention achieves the above objectives by providing a method for preparing a portable booklet of multi-column textual material, comprising reformatting the textual layout of said material in order to create substantial alignment between the lines of text in all of the columns in an area predetermined for horizontal subdivision of the sheet containing the same, creating at least one space horizontally extending across said predetermined area of said sheet, thereby subdividing each of said respective columns to form at least two distinct areas of printed matter, and utilizing said subdivided sheets to form a booklet having pages of reduced height in the direction of its columns, substantially maintaining the original font size of the letters of said multi-column textual material.

In a preferred embodiment of the present invention there is provided a method for preparing a portable booklet of multi-column textual material comprising reformatting the textual layout of said material in order to create substantial alignment between the lines of text in all of the columns in an area predetermined for horizontal subdivision of the sheet containing the same, creating at least one space horizontally extending across said predetermined area of said sheet, thereby subdividing each of said respective columns to form at least two distinct areas of printed matter, folding said sheet across said space to form two interfacing half sheets containing the text from said original one sheet, and binding said folded sheets in consecutive order to form a booklet having pages of reduced height in the direction of its columns while substantially maintaining the original font size of the letters of said multi-column textual material, the fold line of each sheet being adjacent an upper border of said booklet, and constituting an axis for the unfolding and reading of each sheet.

In a further embodiment there is described a method for preparing a portable booklet of multi-column textual material comprising reformatting the textual layout of said material in order to create substantial alignment between the lines of text in all of the columns in an area predetermined for horizontal subdivision of the sheet containing the same, creating at least one space horizontally extending across said predetermined area of said sheet, thereby subdividing each of said respective columns to form at least two distinct areas of printed matter, cutting said sheet across said space to form at least two sheets containing the text from said original one sheet and binding said sheets in consecutive order to form a booklet having pages of reduced height in the direction of the columns while substantially maintaining the original font size of the letters of said multi-column textual material in said columns.

In a most preferred embodiment of the present invention there is provided a multi-column booklet printed using a method described above.

It will be readily understood that a multi-column text cannot be cut or divided by a straight line across the main text because the line alignment of said text is unrelated to the lines carrying text in the side columns. Straight-line division would result in text lines being cut and becoming unreadable and esthetically objectionable even if the lost text is not of major importance.

The novel method of the present invention serves to align side columns and to create a space that allows dividing by folding or cutting the main text into approximately two equal sections without damaging text in side columns.

It should also be realized that according to the present invention the side columns can be vertically moved, compressed or expanded in order to relate more accurately to the main text. As is known, a commentary to the main text is not necessarily precisely opposite the wording to which it refers, and to some extent the method of the present invention allows effecting an improvement in positioning text in the side columns relative to the central text. It is recognized that perfection in this regard will not be achieved as for example a side commentary on the main text may be extensive regarding a first section of a page and totally silent with regard to the remainder of the page. Thus complete alignment of the text and side commentary will not be achieved. Nevertheless any improvement in aligning the content of the side columns with the main text will be of benefit to the reader. Furthermore, as there is no constraint demanding precise division into equal parts, the division can often be effected at the end of a sentence or paragraph of the main text, for further convenience of the reader.

It is to be noted that the method of the present invention is equally applicable to pages wherein the main text occupies the page center or one of the sides or an intermediate position.

While it is clear that any multi-column text as defined in the claims can be reprinted by the method of the present invention, said method is particularly useful—and needed—for texts of Jewish interest, whether in Hebrew, English or any other language. Multi-column books in wide use include the Bible, the Mishna, the Talmud, Maimondes, Mishnah Brura and the Shulchan Aruch (Code of Law by Joseph Caro).

The number of booklets needed to contain the contents of the original book depends on the thickness thereof. A thin book will typically be converted to 2 booklets, while a thick book will be converted to 6 or 8 booklets.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

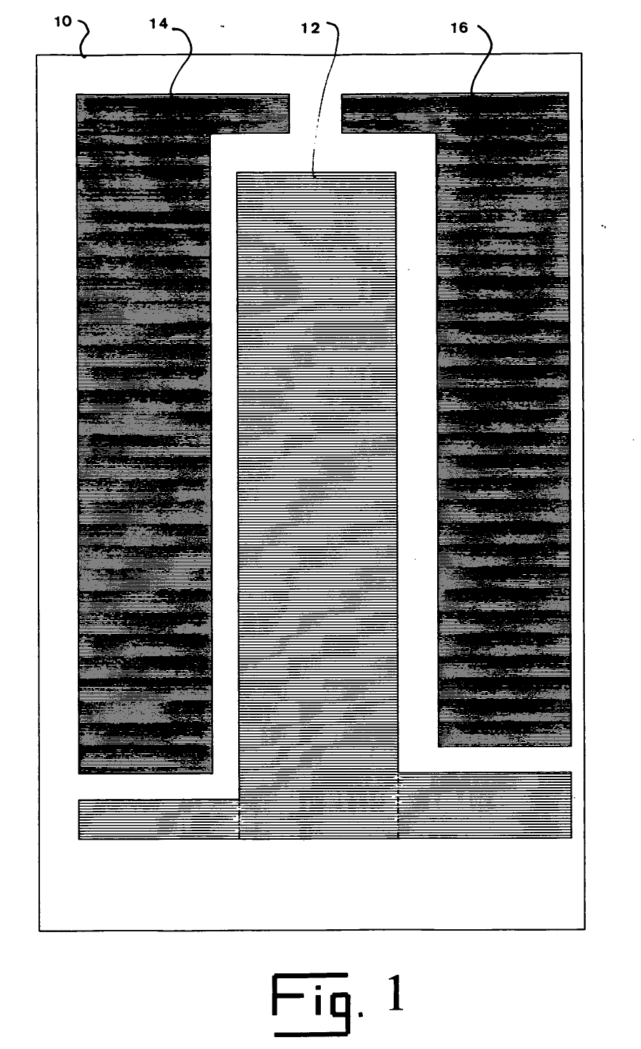

FIG. 1 is a view of a multi-column text page where the main text is disposed in the central column;

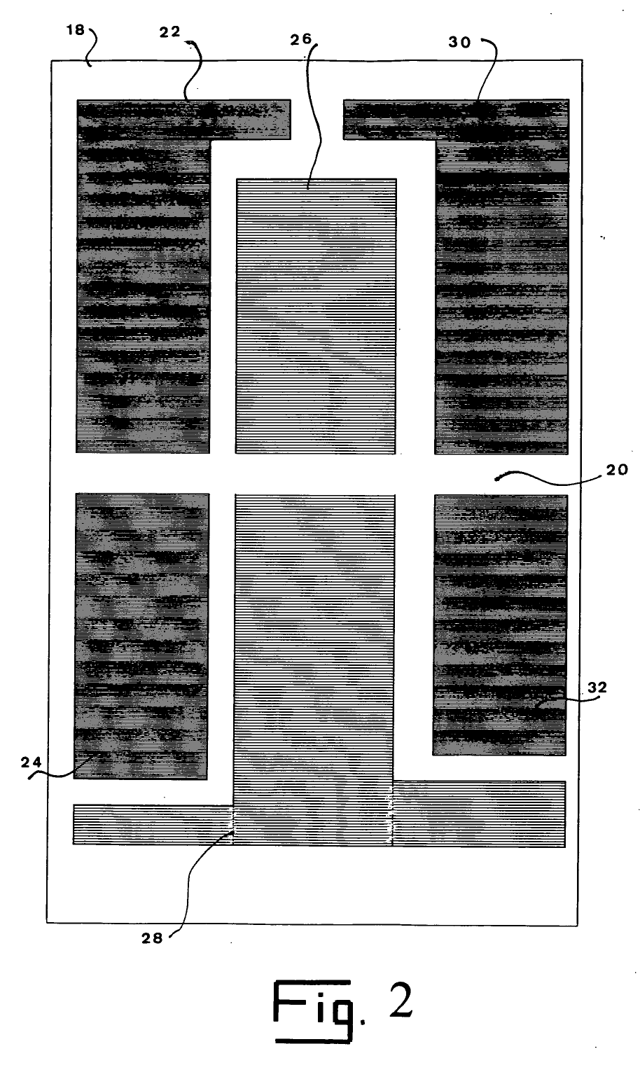

FIG. 2 is a view of the same page after reformatting using the method of the invention;

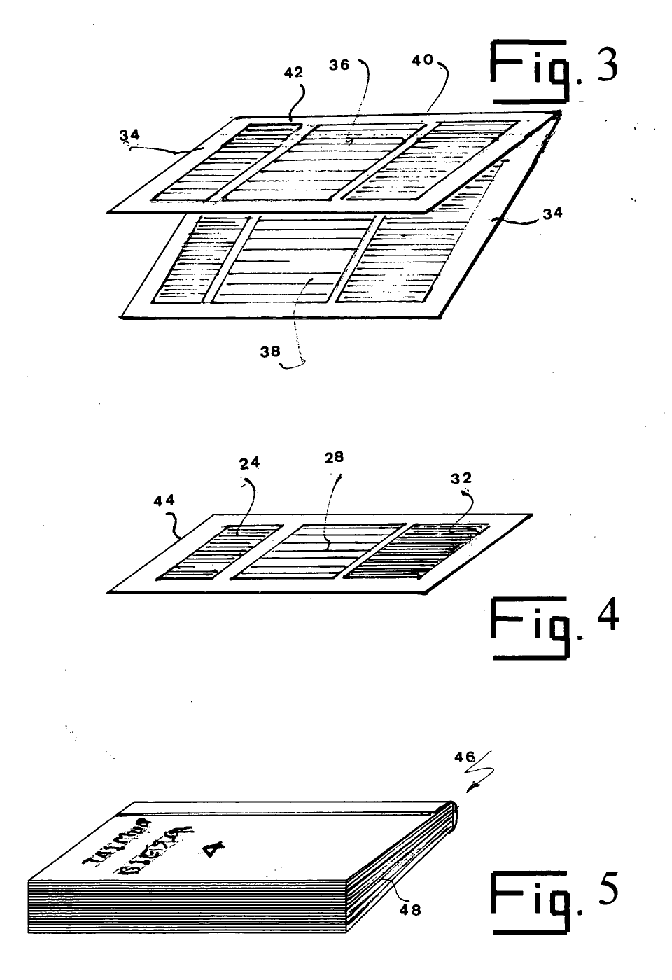

FIG. 3 is a perspective view of a reformatted page that has been folded to form two pages;

FIG. 4 is a perspective view of one of the half-pages cut from a reformatted page; and

FIG. 5 is a perspective view of a bound booklet containing the desired text in a compact form while maintaining font size.

There is seen in FIG. 1 a page 10 of multi-column textual material 12, 14, 16 of the type which is to be processed by the method of the invention.

The method refers to a main text 12, which as seen, may occupy the center of the page 10, and several side columns 14, 16 of translation, commentary or reference notes referring to the main text 12 are set in smaller type.

According to the method, all text 12, 14, 16 is loaded into a computer by scanning for the purpose of reformatting according to the following step.

Referring now to FIG. 2, there is seen a reformatted page 18 carrying the same page of text shown in FIG. 1. The step of reformatting of the textual layout of the material is executed in order to create substantial alignment between the lines of text in all of the columns in an area at or near the center, predetermined for horizontal subdivision of the sheet. A space 20 is created, which extends horizontally across the predetermined area of the sheet, its width being sufficient to allow binding. Thus each of the three columns 12, 14, 16 is subdivided by the space 20 to form two distinct text areas 22-32.

Preferably during reformatting and where possible, advantage is taken of the opportunity to reduce the vertical distances of the content of the side columns to the content of the central column referred to by the side columns.

The next step comprises transferring the reformatted text to a printer and printing the page.

FIG. 3 illustrates a folded sheet 34 containing the text 36 and 38 from two reformatted pages. According to the method the sheet was folded in half, the fold line 40 falling within the horizontal empty space 42. As the next step, the folded sheets are bound in a conventional manner, in consecutive order, to form a booklet, seen in FIG. 5.

The fold line 40 of each sheet is adjacent to an upper border of the booklet, and constitutes an axis for the unfolding and reading of each sheet.

Seen in FIG. 4 is a half sheet 44 cut from a page of the type seen in FIG. 2. Again according to the method, the half-sheets are bound in a conventional manner, in consecutive order, to form a portable booklet of multi-column textual material, as seen in FIG. 5.

Referring now to FIG. 5, there is depicted a bound portable booklet 46, wherein the reformatted text of each page of the original text is split to form two sheets 48 containing said text. The sheets 48 are bound in consecutive order to form a booklet of a size suitable for the use of travelers. The finished booklet is practically identical whether its individual pages were folded or cut.

The finished booklet has pages of reduced height in the direction of its columns. Substantially the original font size of the letters of the multi-column textual material is maintained, and where room allows can even be increased during reformatting.

The booklet 46 is printed on both sides of each page.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method for preparing a portable booklet of multi-column textual material, comprising reformatting the textual layout of said material in order to create substantial alignment between the lines of text in all of the columns in an area predetermined for horizontal subdivision of the sheet containing the same, creating at least one space horizontally extending across said predetermined area of said sheet, thereby subdividing each of said respective columns to form at least two distinct areas of printed matter, and utilizing said subdivided sheets to form a booklet having pages of reduced height in the direction of its columns, while substantially maintaining the original font size of the letters of said multi-column textual material.

2. A method according to claim 1, for preparing a portable booklet of multi-column textual material comprising reformatting the textual layout of said material in order to create substantial alignment between the lines of text in all of the columns in an area predetermined for horizontal subdivision of the sheet containing the same, creating at least one space horizontally extending across said predetermined area of said sheet, thereby subdividing each of said respective columns to form at least two distinct areas of printed matter, folding said sheet across said space to form two interfacing half sheets containing the text from said original one sheet, and binding said folded sheets in consecutive order to form a booklet having pages of reduced height in the direction of its columns while substantially maintaining the original font size of the letters of said multi-column textual material, the fold line of each sheet being adjacent an upper border of said booklet, and constituting an axis for the unfolding and reading of each sheet.

3. A method according to claim 1, for preparing a portable booklet of multi-column textual material comprising reformatting the textual layout of said material in order to create substantial alignment between the lines of text in all of the columns in an area predetermined for horizontal subdivision of the sheet containing the same, creating at least one space horizontally extending across said predetermined area of said sheet, thereby subdividing each of said respective columns to form at least two distinct areas of printed matter, cutting said sheet across said space to form at least two sheets containing the text from said original one sheet and binding said sheets in consecutive order to form a booklet having pages of reduced height in the direction of the columns while substantially maintaining the original font size of the letters of said multi-column textual material in said columns.

4. A portable booklet of multi-column textual material printed and bound according to the method of claim 2.

5. A portable booklet of multi-column textual material printed and bound according to the method of claim 3.
